(19) United States
(12) Patent Application Publication
(10) Pub. No.: US 2019/0050786 A1
(43) Pub. Date: Feb. 14, 2019

(54) Task Assisted Resources Assignment Based On Schedule Impact

(71) Applicant: Dassault Systemes Americas Corp., Waltham, MA (US)

(72) Inventors: Marino Muser, Belmont, MA (US); Manoj Vadicharla, Westford, MA (US); Ashutosh Shekhar, Shrewsbury, MA (US)

(21) Appl. No.: 15/673,787

(22) Filed: Aug. 10, 2017

(51) Int. Cl. G06Q 10/06

(52) U.S. Cl. CPC G06Q 10/063116; G06Q 10/063118; G06Q 10/06393

(57) ABSTRACT

Embodiments of the present invention are direct to computer methods and systems that optimally assign resources for facilitating the execution of tasks. The methods and systems filter available resources for executing a task based on at least one criterion, to produce a set of selected resources. The methods and systems, for each of the selected resources, calculate an impact value associated with assigning the respective selected resource to execute the task. The methods and systems rank the selected resources according to the calculated impact values and generate an optimized schedule for the task based on the ranking of the selected resources. The methods and systems may further program a computer application or cause operation of a device in accordance with the generated optimized schedule for executing the task.

### BACKGROUND

One of the key activities of a project manager, during the planning phase of a project, is to assign resources (people, equipment, and such) for executing project tasks in the project schedule. Although project planning solutions exist to assist the project manager during the project planning phase, these existing solutions do not provide the project manager visibility into how assigning a particular resource to a project task will affect the overall project schedule. As a consequence, a project task may be assigned a resource that is not available at the required execution time of the project task and/or not qualified to execute the project task, thereby negatively impacting the overall project schedule. For example, some existing project planning solutions identify a list of resource candidates for possible assignment to a project task. However, the project manager must manually review the list of resource candidates and select an appropriate resource candidate for the project task, without visibility into the impact the selection will have on the overall project schedule.

### SUMMARY OF THE INVENTION

Embodiments of the present invention provide an improved solution that facilitates assigning resources for executing tasks in a schedule. The improved solution automatically determines the best resource candidates to assign for executing a task in order to optimize the impact on an overall schedule. The solution may measure the impact on the schedule with respect to duration impact, cost impact, quality impact, risk impact, and the like. To measure the impact of assigning each resource candidate to a task, the solution may calculate impact values for each resource candidate and rank the resource candidates based on their calculated impact values. In some example embodiments, for each task, the solution automatically selects the top ranked resource candidate (having optimal impact) for executing the task in the schedule. In other embodiments, for each task, the solution outputs the ranking of the resource candidates and/or their impact values to a user (e.g., project manager). The output provides the user insight to select the optimal resource candidate to assign for executing each task in the schedule. The solution may further use the selections to automatically program applications and cause operation of devices associated with the selected resources.

For example, two resource candidates may be available and have the appropriate capabilities to execute a task. However, the assignment of the first candidates over the second candidate may impact (e.g., reduce) the duration of the schedule by a week and impact (e.g., reduce) the cost associated with the schedule by five percent. Accordingly, the solution calculates duration impact values and cost impact values for each candidate. The impact values each indicate the improved duration impact and cost impact of the first candidate executing the task in comparison to the second candidate executing the task. The solution ranks the two candidates base on the calculated impact values and may automatically select the first candidate for the task based on his higher ranking. The solution may instead indicate the calculated impact values and ranking of each resource candidate to a user and enable the user to select the best candidate (first candidate) for executing the task in the schedule. The solution may further program a calendar application or cause operation of a device associated with the first candidate in accordance with the scheduling of the task.

Embodiments of the present invention are directed to computer-implemented methods and computer systems for assigning resources to facilitate executing a task. The computer systems comprise a processor and a memory with computer code instructions stored thereon. The memory is operatively coupled to the processor such that, when executed by the processor, the computer code instructions cause the computer system to implement an assignment optimization module and a scheduling module. The methods and systems (via the assignment optimization module) filter available resources for executing the task based on at least one criterion, to produce a set of selected resources. In some example embodiments, the selected resources include at least one of: people, equipment, computer processing, and computer memory. In some example embodiments, the criterion is at least one of: capabilities and availability required for the task.

For each of the selected resources, the methods and systems (via the assignment optimization module) calculate an impact value associated with assigning the respective selected resource to execute the task. In some example embodiments, the selected resources are measured according to at least one key performance indicator (KPI), such that the impact value is calculated as a value of the KPI. In some of these example embodiments, the at least one KPI includes: duration impact on the schedule, cost impact on the schedule, quality impact on the schedule, and risk impact on the schedule. The methods and systems (via the assignment optimization module) rank the selected resources according to the calculated impact values. In some example embodiments, the ranking orders the selected resources according to the calculated KPI value associated with assignment of each respective selected resource. In some example embodiments, the ranking of the selected resources is performed in real-time by retrieving at least one criterion and its unit impact for the selected resources from at least one index created in the database.

The methods and systems (via the scheduling module) generate an optimized schedule for the project based on the ranking of the selected resources. In example embodiments, the methods and systems generate the schedule based on user interaction, via a user interface, to select: (i) the at least one criterion and (ii) one or more of the ranked selected resources. In some example embodiments, in generating the schedule, the methods and systems further program at least one of: a calendar application, manufacturing execution system (MES), and an Internet of Things (IoT) computing device. In some example embodiments, in generating the schedule, the methods and systems further cause transferring or configuring a subset of the selected resources at a physical site or on a physical device.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a flow diagram depicting a method of resource assignment in an example embodiment of the present invention.

FIG. 1B depicts an example user interface used to display resource assignment recommendations in an example embodiment of the present invention.

FIG. 2 is a block diagram depicting a system for resource assignment in an example embodiment of the present invention.

FIGS. 3A-3D are block diagrams depicting resource assignment output in an example embodiment of the present invention.

FIG. 4 is a block diagram of a computer (or digital processing) system for resource assignment in at least one embodiment of the present invention.

FIG. 5 is a schematic diagram of an example computer network environment in which embodiments of the present invention may be implemented.

### DETAILED DESCRIPTION OF THE INVENTION

A description of example embodiments of the invention follows.

The described embodiments include methods, systems, and program products that assign resources to facilitate executing tasks. The embodiments select resource candidates for executing a given task from a set of possible resources based on availability, capabilities (qualifications, skills, functionality, and the like), and other such criteria. For example, if a programmer is needed to write a Java program in the second month of a project, the embodiments may select resource candidates from the set of possible resources for the project that are available during the second month of the project and skilled in the Java programming language.

For each of the selected resource candidates, the embodiments calculate impact values (e.g., cost impact, duration impact, quality impact, risk impact, and such) associated with assigning the given resource candidate to execute the task. The embodiments further rank the selected resource candidates according to their calculated impact values. For example, if three Java programmer candidates are selected from the possible engineering resources, the embodiments may calculate cost impact values associated with each of the three programmer candidates. If the three programmer candidates have varying levels of experience, the calculated cost impact values of the programmer candidates may vary according to their levels of experience. Note, in this example, the Java skill requirements are relatively low for the task. So although the associated costs may vary, each of the candidates of varying experience level could perform the task equally. Based on the calculated cost impact values, the programmer candidates may then be ranked, with the least experienced (and least costly) programmer candidate ranked highest and most experienced (and most costly) programmer candidate ranked lowest.

Based on ranking of the selected resource candidates, the embodiments may automatically generate a schedule optimized according to minimized impact. For example, an optimized schedule minimizing cost impact may be generated with the highest ranked (least experienced) programmer candidate assigned to writing the program. The embodiments may also enable interaction with a user, such as a project manager, to generate the scheduling. The embodiments may present the user with the ranking and impact values of the resource candidates, and enable the user to select one of the resource candidates, based on the user's further knowledge and context of the project, to automatically generate the schedule. The embodiments may further automatically program a scheduling related application or device in accordance with the generated schedule. For example, a calendar application used by the selected programmer may be automatically updated to indicate that programmer is scheduled to write the program during the period corresponding to the second month of the project.

### Method of Assigning Resources for Task Execution

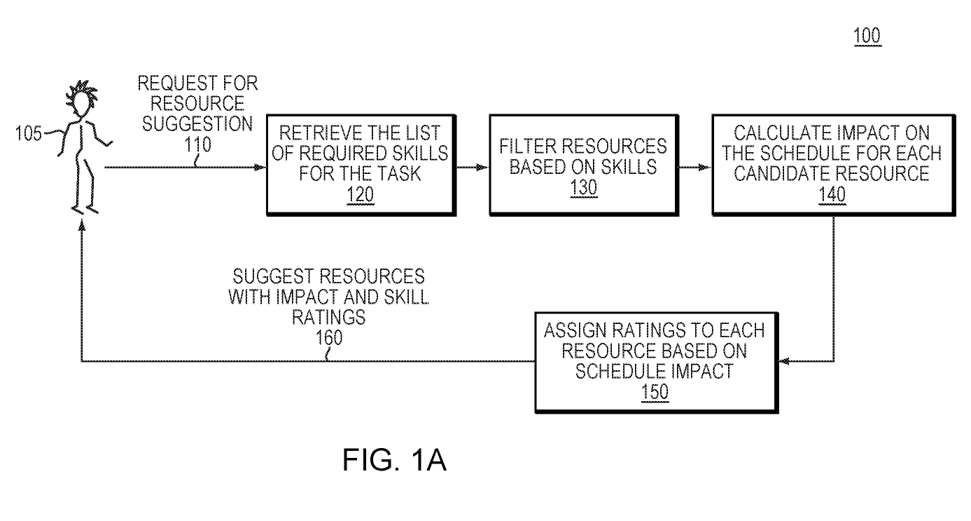

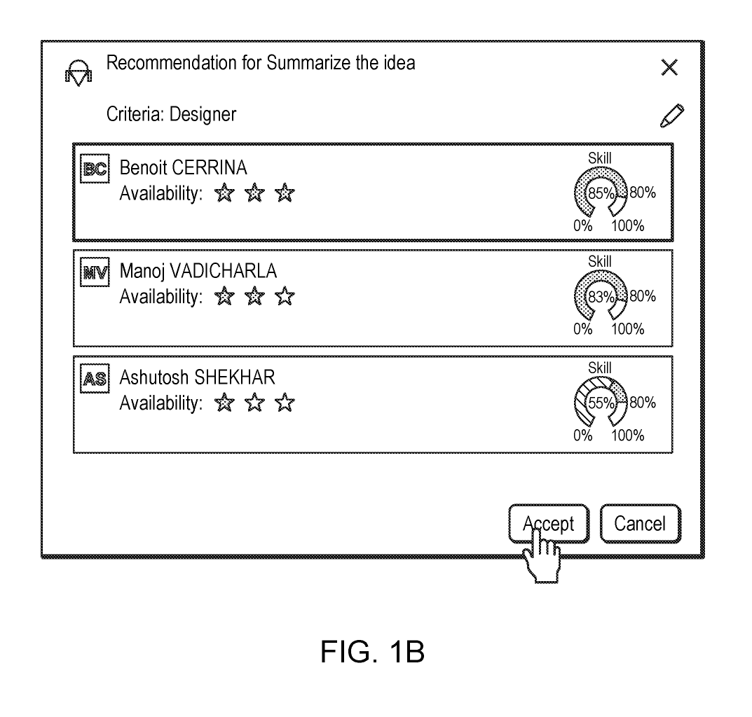

FIG. 1A illustrates a computer method and/or software assembly 100 that assigns resources to facilitate executing a task according to example embodiments of the present invention. The method and/or software assembly 100 is executed by a processor coupled to memory with computer code instructions stored thereon. The step or module 110 (of general method/assembly 100) receives a request, from user 105, to suggest (recommend) resource assignments to facilitate executing tasks in a schedule. For each task, the step or module 120 retrieves a list of at least one required criterion for executing the task, including required capabilities (skills, functionality, and the like) for executing the task, the required time period for executing the task, and other such criteria related to execution of the task. In some example embodiments, the step or module 120 may retrieve the list, in real-time, by accessing indexed database records that associate the task to the required criteria for executing the task. In some example embodiments, the step or module 120 may retrieve the list by enabling the user 105 to interact with method/assembly 100, via a user interface, to enter or select at least one criterion for executing the task. In yet other example embodiments, the step or module 120 may use machine learning techniques that monitor the previous execution of the task or similar tasks and learn the list of criteria required for execution of the task. The step or module 120 may retrieve the learned list of criteria from processes executing the machine learning techniques. In some example embodiments, the step or module 120 periodically collects all the data (e.g., task criteria) for tasks performed by one or more individuals gathering particular skills as an input object and records the execution status (e.g., success or failure) of the performed task as an output value. This task data (input object) and execution status (output value) is used to train a machine learning model. The machine learning model may be configured as a supervised learning category, which may use algorithms like Logistic Regression, Neural Networks and Random Forests to learn the list of task criteria from the input object and output value. Whenever a new instance of the task is to be scheduled, the step or module 120 automatically predicts the individual with the best matched skills set (criteria) based on the task criteria learned by the machine learning model.

The step or module 130 filters available resources for executing the task based on the retrieved list of required at least one criterion. The resources may include people, equipment, computer processing, computer memory, and such. For example, the step or module 130 may filter available manufacturing equipment for producing a product component based on a retrieve list of required functionality of the equipment, availability of the equipment during the required time period, and other required criteria for producing the component. In some example embodiments, the step or module 130 automatically filters the available resources, in real-time, by accessing indexed database records associating each available resource to its capabilities, availability, and other such resource parameters. In example embodiments, the step or module 130 may also access an application, such as a calendar or scheduling application, associated with the resource to determine its availability or other related resource parameters. The step or module 130 may then compare the list of required at least one criterion for the task to the parameters for each available resource. From the comparing of the available resources, the step or module 130 filters the available resources to produce a set of selected resource candidates for executing the task.

In some embodiments, based on the required at least one criterion, step or module 130 may produces no resource candidates for executing the task or may produce a massive number of resource candidates. In these embodiments, step or module 130 may present an interface to enable the user 105 to interact to add or remove criteria, which is then used to re-filter the available resources to produce a more appropriate set of resource candidates for executing the task. For example, method/assembly 100 may be used to assign a resource for execution of computer code, which only runs on a specific type of computer hardware and must be run at a facility in Boston. Based on these specific criteria, the step or module 130 may determine no available computer hardware meets these criteria for executing the computer code task. The user 105 may then be presented with a dialog, or other interface, with an option to modify the required criteria for executing the computer code task. If the user 105 chooses to modify the criteria to remove the location criteria (Boston), the step or module 130 may re-filter the available computer hardware resources to produce a set of computer hardware candidates from other locations (e.g., San Jose), which may remotely be executed for the project in Boston.

For each of the selected resource candidates, the step or module 140 (of general method/assembly 100) calculates impact values associated with assigning the given selected resource candidate to execute the task. The impact values quantitatively indicate the impact on the overall schedule of assigning each given resource candidate for executing the task. In some embodiments, the selected resource candidates are measured according to at least one key performance indicator (KPI), such as duration impact on the schedule, cost impact on the schedule, quality impact on the schedule, risk impact on the schedule, and the like. In some example embodiments, step or module 140 enables the user 105 to interact with method/assembly 100, via a user interface, to choose one or more KPIs for measuring the impact of assigning each selected resource candidate to execute the task. In other example embodiments, step or module 140 automatically chooses one or more KPIs based on the criteria retrieved in step or module 120. In these embodiments, the impact value corresponding to each selected resource candidate is calculated as a value or measurement of the KPI.

For each selected resource candidate, the step or module 140 runs a set of simulations to calculate the impact values of assigning the given resource candidate on the overall schedule. The set of simulations calculates an impact value respective to each required criteria retrieved in step or module 120 for the given resources candidate. The step or module 140 runs the set of simulations and calculates corresponding impact values with respect to each of the one or more KPIs chosen for measuring the overall impact on the schedule. Based on the KPI, the required criteria may be weighed differently by the set of simulations in calculating the impact values. For example, availability of a resource at a specific time period may be given more weight with respect to calculating duration impact that calculating cost impact. In some example embodiments, for each KPI, the calculated impact (unit impact) values respective to each required criteria may be combined to calculate a cumulative impact value for the given resource candidate for that KPI. In some of these example embodiments, the cumulative impact value from each KPI may be further combined into a total impact value for the given resource candidate across KPIs.

The step or module 150 assigns a ranking to each of the selected resource candidates based on comparing the calculated impact values associated with the respective resource candidate. Based on the rankings of the selected resource candidates, the step or module 160 recommends one or more of the selected resource candidates to the user 105. In some example embodiments, the step or module 160 may provide recommendations to the user 105 by presenting, via a user interface, a shortened list of the most suitable resource candidates, along with their corresponding rankings and calculated impact values. The user 105 may then use the rankings and impact values, along with other knowledge and context possessed by the user 105, to select a particular resource candidate to schedule for executing the task. For example, the step or module 150 may present the most suitable resource candidates to the user 105 via the example user interface of FIG. 1B. The example user interface of FIG. 1B presents each of the most suitable resource candidates together with the candidate's availability (as a star ranking) and the candidate's matching skill level for performing the task (as a percentage). The user 105, via the example user interface, may then highlight one of the presented candidates (e.g., candidate Benoit as shown) and select the “Accept” button to select that candidate to schedule for executing the task. Note that FIG. 1B is only an example, and the underlying user interface can be implemented in other ways. In other example embodiments, the step or module 160 may automatically assign the top ranked resource candidate to each respective task in a manner that generates an optimized overall schedule.

The step or module 160 may further automatically program a calendar application, manufacturing execution system (MES), Internet of Things (IoT) computer device, or such according to the generated schedule. The step or module 160, based on the generated schedule, may also cause transferring or configuring the selected resource candidates for executing some tasks to a physical site or physical device. In some example embodiments, the step or module 160 can use enterprise transaction modules to communicate with plant floor equipment and update production calendars. In other example embodiments, the step or module 160 may utilize message queuing protocols, such as Advanced Message Queuing Protocol (AMQP), for communication with an IoT computer device to update distributed schedules used by the device.

For example, if an assigned resource is a person, step or module 160 may automatically update an automated calendar application for that person to indicate that person is now scheduled to execute the task at the scheduled time period (and unavailable for other tasks). Similarly, if the assigned resource candidate is a piece of equipment, conference room, and the like, step or module 160 may update an enterprise scheduling application or system related to that resource to indicate the resource is now unavailable at the scheduled time period for executing other tasks. For another example, if the assigned resource candidate is manufacturing equipment (machine), the step or module 160 may automatically provide the generated schedule to a MES, which automatically causes movement of the machine to a particular location at the scheduled time period for executing the task and/or automatically programs the machine to execute the task during the time period. For a further example, if the assigned resource is IoT device, such as a Wi-Fi surveillance camera, the step or module 160 may cause operation (control) of the device in accordance with the generated schedule. In particular, the step or module 160 may program the Wi-Fi surveillance camera to start and stop recording according to the scheduled time period in the generated schedule.

System that Assigns Resources for Task Execution

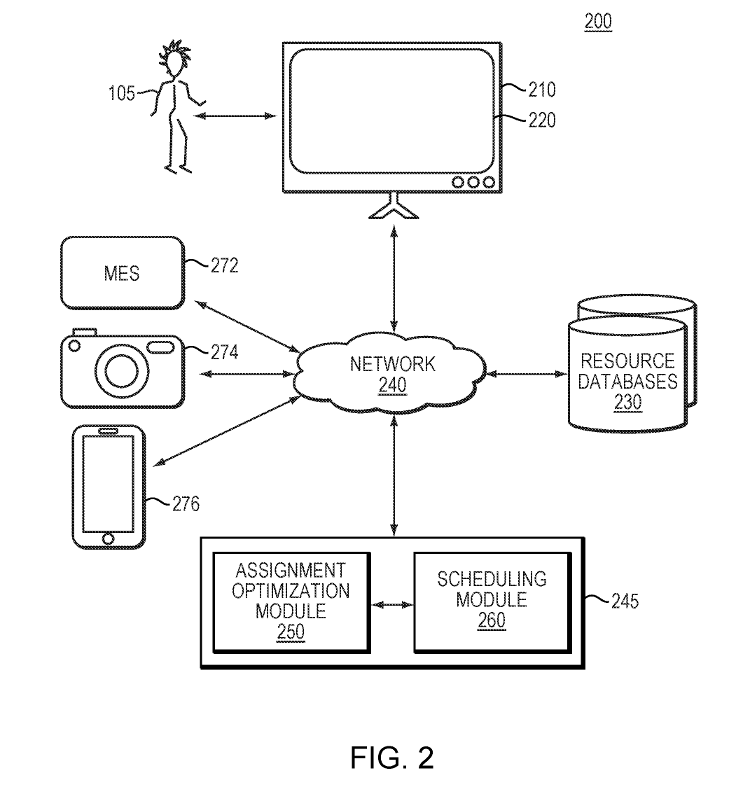

The block diagram of FIG. 2 depicts a system 200 configured to assign resources to facilitate executing a task according to example embodiments of the present invention. The system 200 includes a display device 210 that enables a user 105 (e.g., project manager) to interact with the system 200 via a user interface 220 presented on the display device 210. The user 105 provides input (selects an option) on the user interface 220 of the display device 210 to commence the process of assigning resources to execute tasks in a schedule. As part of the input, the user 105 may indicate one or more tasks to be assigned resources in the schedule. The user 105 may select the one or more tasks from a list presented on the user interface 220, enter the name of the one or more task in a field presented on the user interface 220, input a schedule document containing the one or tasks to the user interface 220, or using any other method known in the art to provide input via a user interface 220. As part of the input, the user 105 may also select one or more KPIs (e.g., duration impact, cost impact, and the like) as a measurement for recommending resources to assign for executing each task. Similar to the task input, the user 105 may select the one or more KPIs from a list presented on the user interface 220, enter the name of the one or more KPIs in a field presented on the user interfaced 220, or using any other method known in the art to provide input via an interface 220.

The display device 210 communicates the user input (via network 240) to a computing device (server) 245. The computing device 245 is configured with one or more processors operatively coupled to memory with computer code instructions stored thereon, such that when executed by the processor, the computer code instructions cause the one or more processors to implement an assignment optimization module 250 and a scheduling module 260. The computing device 245 processes the received user input by the assignment optimization module 250, which accesses the resource databases 230 communicatively coupled to the computing device 245 via network 240. The resource databases 230 are structured such that tasks (including the one or more tasks input by the user 105) are stored associated to at least one criterion for executing the respective task. Such structuring enables the assignment optimization module 250 to index and extract the at least one criterion for a given task from records of the resource databases 230 in real-time. Further, as the at least one criterion for a given task changes, such as by machine learning processes automatically learning additional/different criteria for a given task or users specifying additional/different criteria for a given task, the structuring enables immediate updating of the resource databases 230 with the changed criteria. Thus, enabling the assignment optimization module 250 access, in real-time, to the current criteria for executing a given task from the resource databases 230 as the criteria changes.

The assignment optimization module 250 accesses the resource databases 230 to determine the at least one criterion for each of the one or more tasks input by the user 105. In other example embodiments, the assignment optimization module 250 may instead interact with the user via the user interface 220 (via network 240) to prompt the user to input at least one criterion for each of the one or more tasks.

For each task, based on the determined at least one criterion for the given task, the assignment optimization module 250 further accesses the resource databases 230 to determine possible (available) resources to assign for executing the given task. The resource databases 230 are further structured such that the possible resources (e.g., people, equipment, and such) are stored associated to parameters or criteria related to the respective resource (e.g., availability, capability, functionality, skillset, and such). Such structuring enables the assignment optimization module 250 to index and compare the parameters for a given resource in the resource databases 230 to the at least one criterion for a given task. Further, as the parameters for a given resource changes, such as by users specifying additional/different parameters for the given resource, the resource databases 230 may be immediately updated with the changed parameters for the given resource. Thus, enabling the assignment optimization module 250 access, in real-time, to the current parameters for a given resource from the resource databases 230 as the parameters change. For example, if one of the parameters associated to a given resource is cost which changes over time (e.g., inflates higher during a weekend or during certain seasons), the assignment optimization module has 250 real-time access to the current cost of the given resource as its cost changes.

For a given task, the assignment optimization module 250 compares (filters) the at least one criterion for the given task against the parameters associated with each resource in the resource databases 230, to produce a set of selected resource candidates. If the filtering produces no resource candidates or a massive number of resource candidates for executing the given task, the assignment optimization module 250 may present (e.g., via a dialog) the at least one criteria for the given task to the user 105 at the user interface 220 (via network 240). The user may interact with the user interface 220 to add or remove items from the at least one criteria for executing the given task. The assignment optimization module 250 may then compare the updated at least one criterion for the given task against the parameters associated with each resource in the resource databases 230, to produce a new set of selected resource candidates.

For each of the selected resource candidates, the assignment optimization module 250 calculates impact (unit impact) values with respect to the one or more KPIs input by the user 105. For example, for each KPI, the assignment optimization module 250 may execute a set of simulations that calculates an impact value with respect to each of the at least one criterion for executing the task. To do so, the assignment optimization module 250 may compare each task criterion against parameters associated with the resource candidate in the resource databases 230, to determine a quantitative impact value indicating how closely the task criterion matches the parameters. Based on the KPI being used as an impact measurement, the assignment optimization module 250 may also applying a weighing to the quantitative impact value calculated with respect to each criterion. For example, the criterion of availability may be more important with the respect to the KPI of impact duration than impact cost, and thus may be given a larger weighing when calculating impact duration for a resource candidate. In some embodiments, for a selected resource candidate, the impact values with respect to each criterion may be combined to calculate a cumulative impact value for each KPI. In some of these embodiments, the cumulative impact value for each KPI may be further combined into a total impact value for the selected resource candidate.

For each task, the assignment optimization module 250 may then rank each of the selected resource candidates based on comparing their respective calculated impact values (or cumulative/total impact values). In some example embodiments, for each task, the assignment optimization module 250 may interact with the display device 210 (via network 240) to present the ranked resource candidates and corresponding calculated impact values to the user 105 at the user interface 220. The user 105 may review the ranked resource candidates and calculated impact values, in view of other knowledge and context possessed by the user 105, to select a particular resource candidate for the task. The display device 210 may communicate the user's selection back to the assignment optimization module 250 (via network 240). In other example embodiments, for each task, the assignment optimization module 250 may automatically select the highest ranked resource candidate for the task (without presenting the ranking to the user 105). The assignment optimization module 250 communicates the selection for each task to the scheduling module 260. The scheduling module 260 generates a schedule including the one or more tasks, with each task assigned the respective selected resource candidate. The scheduling module 260 further communicates with computer applications and devices 272, 274, 276 to program these applications/devices based on the generated schedule.

For example, if the selected resource is a person, the scheduling module 260 (via network 240) may communicate with a calendar application executing on the resource's mobile device 276. The scheduling module 260 may automatically update the selected resource's calendar configured in the calendar application to indicate the selected resource is assigned to execute the task at a certain time period. The schedule module 260 may also automatically update the enterprise calendar configured in a calendar application for the organization (not shown). The resource's calendar on the resource's mobile device 276 may then be automatically updated (synchronized) from the enterprise calendar of the organization.

For another example, if the selected resource is a Wi-Fi surveillance camera (IoT device) 274, the scheduling module 260 (via network 240) may automatically cause operation of the camera 274 based on the task assignment. For example, the scheduling module 260 may program the processor system that controls the camera 274 (via network 240), in accordance with the scheduled time period, for the processor system controlling the camera 274 to automatically start/stop recording surveillance at the scheduled time period.

For a further example, if the selected resource is manufacturing equipment (machine), the scheduling module 260 (via network 240) may communicate with the Manufacturing Execution System (MES) to reserve the machine during the schedule time period based on the criteria of the task. The reservation of the machine via the MES may cause the machine (e.g., concrete mixer) to be: moved to a particular physical location (e.g., construction site) to execute the task, configured according to the task (e.g., configured to mix a particular type of concrete), and controlled to start/stop execution of the task in accordance with the scheduled time period.

### Examples of Resource Assignment Output

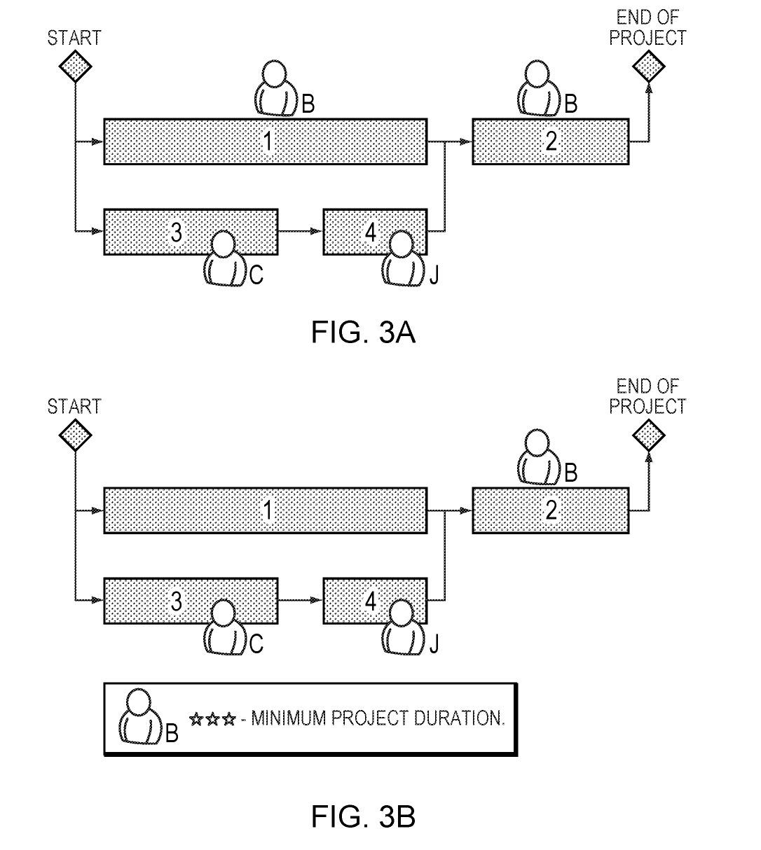

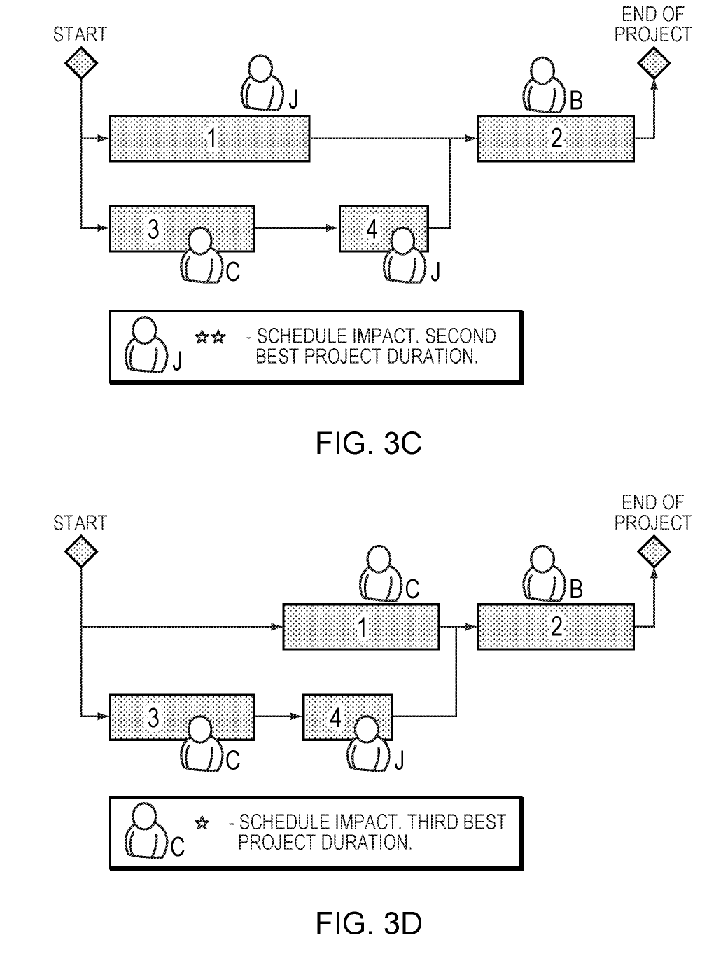

FIGS. 3A-3D depict resource assignment output provided to a user in example embodiments of the present invention. In FIGS. 3A-3D, the user (e.g., project manager) requests a system to automatically recommend an available resource to assign for executing task 1 in a project schedule. The user further requests that the system determine the recommendation using project duration as the KPI to measure the impact of each available resource on the overall project schedule. In FIGS. 3A-3D, all tasks except task 1 (i.e., tasks 2-4) have already been assigned resources in the project schedule. In some example embodiments, system 200 of FIG. 2 and/or method 100 of FIG. 1A may be used to perform the resource assignment depicted in FIGS. 3A-3D.

The system filters the available resources for executing task 1 based on the criteria of availability and capabilities required for executing task 1. As shown in FIG. 3A, the system filters all available resources to three resource candidates, Bill (B), Jack (J), and Carl (C), that meet the criteria for executing task 1. These three resource candidates B, J, C are already assigned, to other tasks 2, 3, and 4, respectively, in the project schedule. The three resource candidates are all at a similar level of capability for executing the task. Therefore, the system calculates a project duration impact value for each of the three resource candidates based only on their availability (i.e., their other assigned project tasks). Based on the calculated project duration impact values, the system ranks (recommends) the resource candidates B, J, C according to a star ranking, with three-stars being the top ranked resource candidate and one-star being the bottom ranked resource candidate.

As shown in FIG. 3B, the system calculates the best project duration impact value for resource candidate B and recommends resource candidate B as the first-ranked candidate with three-stars. The system calculates the best project duration impact value for resource candidate B because of his availability during the entire time period of task 1 (as his other project task 2 is not scheduled until the completion of task 1). Therefore, the assignment of resource candidate B for executing task 1, from among the three selected candidates, would result in the minimum project duration (earliest possible project completion date). The system presents the top recommendation of resource candidate B for executing task 1 to the user. If the user selects resource candidate B for executing task 1, as recommended, the system automatically updates resource candidate B's calendar, as managed in an enterprise or personal calendar application, according to as shown in FIG. 3B.

As shown in FIG. 3C, the system calculates the second best project duration impact value for resource candidate J and recommends resource candidate J as the second-ranked candidate with two-stars. The system calculates the second best project duration impact value for resource candidate J because of his availability during most of the time period of task 1 (as his other project task 4 only overlaps a portion of the time period of task 1). Therefore, the assignment of resource candidate J for executing task 1, from among the three selected candidates, would result in the second minimum project duration (second earliest possible project completion date). That is, as shown in FIG. 3C, the movement (delay) of executing task 4, to enable resource candidate J to execute both task 1 and task 4, would have only a slight duration impact on the overall project schedule. If the user selects resource candidate J for executing task 1, the system automatically updates resource candidate J's calendar, as managed in an enterprise or personal calendar application, according to as shown in FIG. 3C.

As shown in FIG. 3D, the system calculates the third best project duration impact value for resource candidate C and recommends resource candidate C as the third-ranked candidate with one-star. The system calculates the third best project duration impact value for resource candidate C because of his availability during only a small portion of the time period for task 1 (as his other project task 3 overlaps a significant portion of the time period of task 1). Therefore, the assignment of resource candidate C for executing task 1, from among the three selected candidates, would result in the third minimum project duration (third earliest possible project completion date). That is, as shown in FIG. 3D, the movement (delay) of executing task 1, to enable resource candidate C to execute both task 1 and task 3, would have the largest duration impact on the overall project schedule. If the user selects resource candidate C for executing task 1, the system automatically updates resource candidate C's calendar, as managed in an enterprise or personal calendar application, according to as shown in FIG. 3D.

### Digital Processing Environment

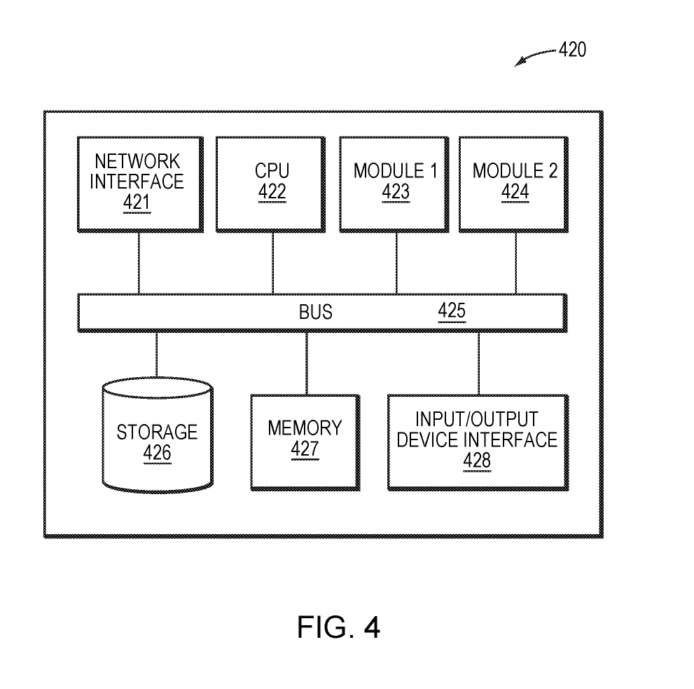

FIG. 4 is a simplified block diagram of an example computer-based system 420 that may be used to assigning resources to facilitate executing a task according to an embodiment of the present invention. The system 420 comprises a bus 425. The bus 425 serves as an interconnector between the various components of the system 420. Connected to the bus 425 is an input/output device interface 428 for connecting various input and output devices such as a keyboard, mouse, display (e.g., 210 of FIG. 2), speakers, etc. to the system 420. Input/output device interface 428 may connect a display to the system 420 to enable a user to view and select (i) criteria for selecting among available resources and (ii) resources from among the ranked selected resources as described in references to FIGS. 1, 2, and 3A-3D. A central processing unit (CPU) 422 is connected to the bus 425 and provides for the execution of computer instructions. Memory 427 provides volatile storage for data used for carrying out computer instructions. Storage 426 provides non-volatile storage for software instructions, such as an operating system (not shown). In particular, memory 427 and/or storage 426 may be configured with program instructions implementing methods 100 of FIG. 1A for assigning resources to facilitate executing a task. The memory 427 and/or storage 426 may also be configured with the Resource Databases 230 of FIG. 2, which may contain resources indexed to resource parameters and task criteria. The system 420 also comprises a network interface 421 for connecting to any variety of networks known in the art, including cloud-based networks, wide area networks (WANs) and local area networks (LANs), such as the network 240 of FIG. 2.

Further connected to the bus 425 is a first module 423. The first module 423 is configured as an assignment optimization module for selecting resource candidates, calculating impact values for the selected resource candidates, and ranking the selected resource candidates based on the calculated impact values. The first module (assignment optimization module) 423 may provide loading and displaying functions through any means known in the art to enable the user to view and select criteria for determining resource candidates and calculating the impact values for the determined resource candidates. For example, the first module 423 may reference available resources, associated resource parameters, and criteria for executing tasks stored on the storage device 426 or memory 427. For another example, the first module 423 may load the available resources, associated resource parameters, and criteria for executing tasks from any point communicatively coupled to the system 420 via the network interface 421 and/or input/output device interface 428, such as Resource Databases 230. For further example, the first module 423 may calculate impact values associated with assigning the selected resource candidates for executing a task and may rank the selected resource candidates by the calculated impact values at the CPU 422 via the bus 425.

The system 420 further comprises a second module 424 configured as a scheduling module for generating and programming a schedule from the ranked resource candidates. The second module 424 that is communicatively/operatively coupled to the first module 423. The second module (scheduling module) 424 is configured to automatically generate an optimized schedule from the resource candidates selected and ranked at the first module 423. The second module 424 may provide scheduling and programming through any means known in the art. For example, the second module 424 may store the generated schedule at the storage device 426 or memory 427. For another example, the second module 424 may generated the schedule at the CPU 422 from the impact values calculated at the first module 423 via the bus 425. For further example, the second module 424 may program an application or cause operation of a device at any point communicatively coupled to the system 420 via the network interface 421 and/or input/output device interface 428 according to the generated schedule.

It should be understood that the example embodiments described herein may be implemented in many different ways. In some instances, the various methods, systems, and application/devices described herein (FIGS. 1, 2, and 3A-3D) may each be implemented by a physical, virtual, or hybrid general purpose computer, such as the computer system 420. The computer system 420 may be transformed into the machines that execute the methods described herein, for example, by loading software instructions into either memory 427 or non-volatile storage 426 for execution by the CPU 422. Further, while the first module 423 and second module 424 are shown as separate modules, in an example embodiment these modules may be implemented using a variety of configurations.

The system 420 and its various components may be configured to carry out any embodiments of the present invention described herein. For example, the system 420 may be configured to carry out the method 100 described hereinabove in relation to FIG. 1A. In an example embodiment, the first module 423 and second module 424 may be implemented in software that is stored on the memory 427 and/or storage device 426. In such an example embodiment, the CPU 422 and the memory 427 with computer code instructions stored on the memory 427 and/or storage device 426 implement a first module 423 that selects resource candidates, calculates impact values for the selected resource candidates, and ranks the selected resource candidates based on the calculated impact values. Further, the components of the system 420 implement a second module 22 that is operatively coupled to the first module and configured to generate and program a schedule from the ranked resource candidates.

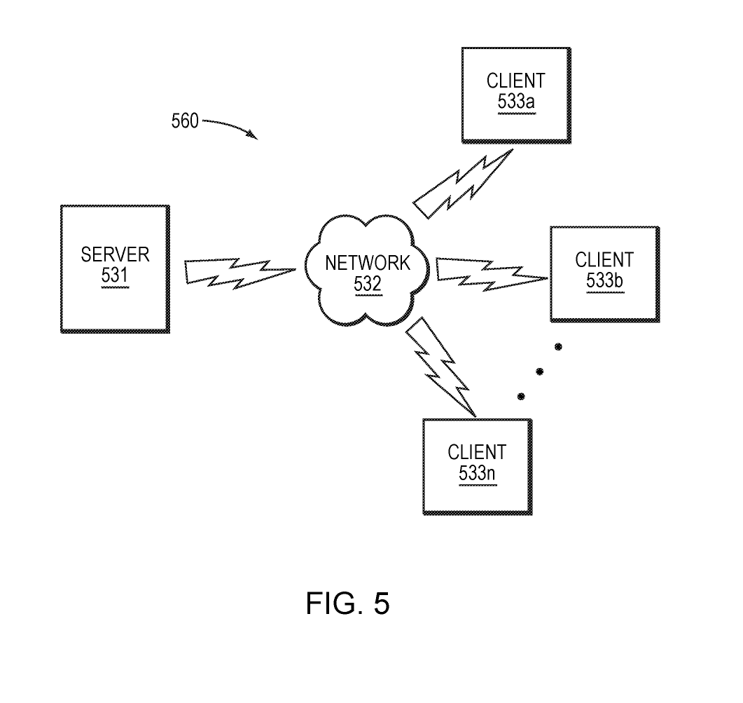

FIG. 5 illustrates a computer network environment 560 in which an embodiment of the present invention may be implemented. In the computer network environment 560, the server 531 is linked through the communications network 532 to the clients 533a-n. The environment 560 may be used to allow the clients 533a-n, alone or in combination with server 531, to execute any of the methods (e.g., methods 100) or systems (e.g., system 200) described hereinabove. It should be understood that the example embodiments described above may be implemented in many different ways. In some instances, the various methods and systems described herein may each be implemented by a physical, virtual, or hybrid general purpose computer, or a computer network environment such as the computer environment 560.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to program or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices/machines executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-implemented method of assigning resources to facilitate executing a task, the method comprising:
by a processor coupled to a memory with computer code instructions stored thereon:
filtering available resources for executing the task based on at least one criterion, to produce a set of selected resources;
for each of the selected resources, calculating an impact value associated with assigning the respective selected resource to execute the task;
ranking the selected resources according to the calculated impact values; and
generating an optimized schedule for the task based on the ranking of the selected resources.

2. The method of claim 1, wherein the at least one criterion is at least one of: capabilities and availability required for the task.

3. The method of claim 1, wherein the selected resources are measured according to at least one key performance indicator (KPI), such that the impact value is calculated as a value of the KPI.

4. The method of claim 3, wherein the at least one KPI includes: duration impact on the schedule, cost impact on the schedule, quality impact on the schedule, and risk impact on the schedule.

5. The method of claim 3, wherein the ranking orders the selected resources according to the calculated KPI value associated with assignment of each respective selected resource.

6. The method of claim 1, wherein: generating the schedule based on user interaction, via a user interface, to select: (i) the at least one criterion and (ii) one or more of the ranked selected resources.

7. The method of claim 1, wherein the selected resources include at least one of: people, equipment, computer processing, and computer memory.

8. The method of claim 1, wherein the ranking of the selected resources is performed in real-time by retrieving the at least one criterion and the unit impact for the selected resources from at least one index in a database.

9. The method of claim 1, wherein the generating of the schedule comprises automatically programming at least one of: a calendar application, manufacturing execution system (MES), and an Internet of Things (IoT) computing device.

10. The system of method 1, wherein the generating of the schedule causes transferring or configuring a subset of the selected resources at a physical site or on a physical device.

11. A computer system for assigning resources to facilitate executing a task, the system comprising:
a processor; and
a memory with computer code instructions stored thereon, the memory operatively coupled to the processor such that, when executed by the processor, the computer code instructions cause the computer system to implement:
an assignment optimization module configured to:
filter available resources for executing the task based on at least one criterion, to produce a set of selected resources;
for each of the selected resources, calculate an impact value associated with assigning the respective selected resource to execute the task; and
rank the selected resources according to the calculated impact values; and
a scheduling module configured to:
generate an optimized schedule for the task based on the ranking of the selected resources.

12. The system of claim 11, wherein the at least one criterion is at least one of: capabilities and availability required for the task.

13. The system of claim 11, wherein the selected resources are measured according to at least one key performance indicator (KPI), such that the impact value is calculated as a value of the KPI.

14. The system of claim 13, wherein the at least one KPI includes: duration impact on the schedule, cost impact on the schedule, quality impact on the schedule, and risk impact on the schedule.

15. The system of claim 13, wherein the ranking orders the selected resources according to the calculated KPI value associated with assignment of each respective selected resource.

16. The system of claim 11, wherein: the scheduling module generating the schedule based on user interaction, via a user interface, to select: (i) the at least one criterion and (ii) one or more of the ranked selected resources.

17. The system of claim 11, wherein the selected resources include at least one of: people, equipment, computer processing, and computer memory.

18. The system of claim 11, wherein the scheduling module performs the ranking of the selected resources in real-time by retrieving the at least one criterion and the unit impact for the selected resources from at least one index in a database.

19. The system of claim 11, wherein the scheduling module is further configured to automatically program at least one of: a calendar application, manufacturing execution system (MES), and an Internet of Things (IoT) computing device.

20. The system of claim 11, wherein the scheduling module generating the schedule causes transferring or configuring a subset of the selected resources at a physical site or on a physical device.
